(19) United States
(12) Patent Application Publication
(10) Pub. No.: US 2016/0031342 A1
(43) Pub. Date: Feb. 4, 2016

(54) BACK SEAT OCCUPANT DETECTOR AND ALARM

(71) Applicant: Continental Automotive Systems, Inc., Auburn Hills, MI (US)

(72) Inventors: Bob C. Camello, Vernon Hills, IL (US); Irina Shmagin, Palatine, IL (US); Marc William Piszkiewicz, Gurnee, IL (US)

(21) Appl. No.: 14/448,083

(22) Filed: Jul. 31, 2014

(51) Int. Cl. B60N 2/00

(52) U.S. Cl. CPC B60N 2/002

(57) ABSTRACT

A person, animal, or object in the back seat of a motor vehicle can be presumed to have been inadvertently left there if a back seat access device such as a rear door or seatback of a front seat has been used, followed by the closure of a door lock and not followed by a second usage of the back seat access device. When a person, animal, or object is determined to have been inadvertently locked in the vehicle, an alarm is automatically generated by the vehicle, which notifies the driver, by-standers, and/or an emergency service provider.

### BACKGROUND

Infants, toddlers, and pets are sometimes left in the back seat of a vehicle inadvertently. When that happens during summer months, a child or pet can be abducted, injured, or killed by the excessive temperatures that build up inside the vehicle. An apparatus or method to alert someone that a person or animal is in the backseat of a vehicle might prevent tragic accidents from occurring.

### BRIEF SUMMARY

In accordance with embodiments of the invention, a person, animal, or object in the back seat of a motor vehicle can be presumed to have been inadvertently left there if a back seat access device such as a rear door or seatback of a front seat has been used, followed by the closure of a door lock and not followed by a second usage of the back seat access device. When a person, animal, or object is determined to have been inadvertently locked in the vehicle, an alarm is automatically generated by the vehicle, which notifies the driver, by-standers, and/or an emergency service provider.

### BRIEF DESCRIPTION OF THE DRAWINGS

FIG. 1 is a side view of a passenger car having two doors;

FIG. 2 is a top view of a four-door passenger vehicle;

FIG. 3 is a schematic diagram of an apparatus for detecting an occupant in the back seat of a motor vehicle;

FIG. 4 is a flow chart depicting a method of detecting an occupant in the back seat of a motor vehicle and which can be performed using the apparatus shown in FIG. 3.

### DETAILED DESCRIPTION

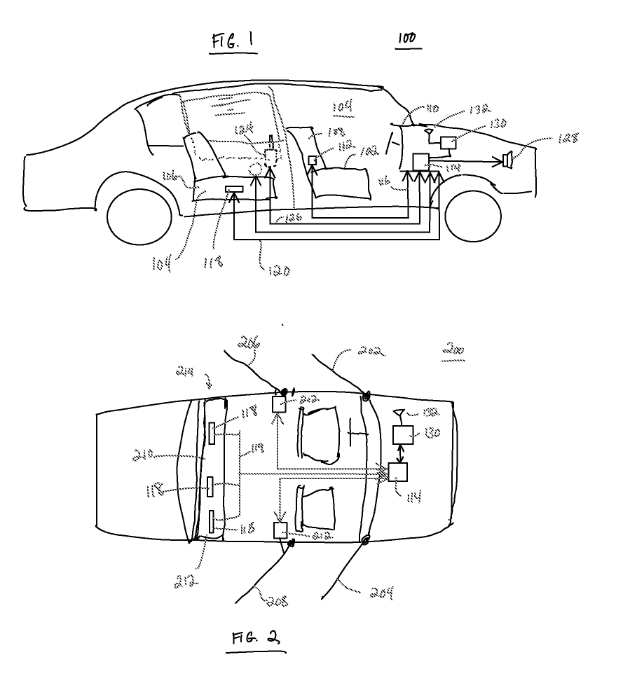

FIG. 1 is a side view of a motor vehicle 100 having two passenger compartment doors that are removed to reveal a front passenger seat 102 in the vehicle's passenger compartment 104. A rear seat 104 is accessible from the door by tilting the seatback 108 of the front seat 102 forward, i.e. toward the dash board 110.

The seatback 108 of the front seat 102 is provided with a sensor 112 which is coupled to a processor 114 through a cable 116. The sensor 112 is preferably embodied as an inclinometer or accelerometer, which are well-known semiconductor devices. The sensor 112 provides an analog output voltage that is proportional to the angle of inclination of the seatback 108 relative to horizontal. The sensor 112 thus provides an electrically-measurable signal as the seatback 108 is moved forward to provide access to the rear seat 104. The seatback 112 of a two-door vehicle 100 is thus considered herein to be rear-seat access device.

The rear seat 104 has an occupant sensor 118 embedded in or located below the seat cushion portion 106 of the rear seat 104. The occupant sensor 118 can be considered to be electrically equivalent to a single-pole, double-throw switch, (SPDT), i.e., a switch that connects either of two terminals to a common terminal, responsive to the presence of a predetermined weight on the seat cushion 106.

The occupant sensor 118 is coupled to the processor 114 through a wire or cable 120. When the seat cushion 106 is open or unoccupied the occupant sensor 118 can provide either ground (zero volts) or a positive-valued voltage to the processor. When the seat cushion 106 is occupied with a weight greater than a predetermined amount, typically chosen to be no more than the weight of an infant, the occupant sensor 118 will provide either a positive-valued voltage or ground (zero volts). The occupant sensor thus provides a signal to the processor 114 that essentially “tells” the processor 114 that a person or object is on the seat cushion portion 106 or that the seat cushion portion 106 is unoccupied.

Motor vehicle doors are commonly provided with locks. When the vehicle door lock is closed, the door cannot be opened from the outside of the vehicle without a key or a code to unlock an electronic combination lock.

FIG. 1 shows a motor vehicle door lock position sensor 124, which is coupled to the processor 114 through a cable 126. The door lock position sensor 124 comprises a center contact of a single-pole, double-throw switch. It can therefore provide either a ground or positive voltage, both of which are detectable by the processor 114, when the door locks are open or closed. A door lock position sensor 124 is provided for both door locks of the two doors found in a two-door vehicle depicted in FIG. 1. A door lock position sensor is also provided for each of the four door locks of a four-door vehicle such as the one depicted in FIG. 2.

Still referring to FIG. 1, the processor 114, which is a prior art microprocessor, is coupled to an electrically-operated alarm device 128. The alarm device 128 is preferably embodied as the vehicle's horn.

The processor 114 is also coupled to a prior art telematics device 130. Such devices are well known to those of ordinary skill in the automotive electronics art.

The telematics device 130 is essentially a radio frequency transceiver coupled to a wireless network through a conventional antenna 132. The telematics device 130 is thus able to send and receive signals to and from a telematics service provider not shown but well known in the art.

FIG. 2 is a top view of a four-door vehicle 200. The vehicle has two front doors 202, 204 and two rear doors 206, 208. The rear doors 206, 208 provide ready access to the rear seat 210. The two rear doors 206 and 208 are thus considered herein to be rear seat access devices for a vehicle having four passenger compartment doors.

The vehicle doors 202, 204, 206, 208 are each provided with door closure switches, two of which are shown in FIG. 2 and identified by reference numerals 212. The door closure switches 212, which are also SPDT switches, are opened and closed respectfully when the doors 206, 208 are opened and closed.

The center contacts of the door closure switches are coupled to a processor 114. They provide two different electrically measurable signals to the processor 114 when the doors 206 and 208 are opened and closed respectively. A first signal can be either ground or a positive voltage when the door is open. A second signal can be either a positive voltage or ground when the door is closed.

As with the vehicle 100 shown in FIG. 1, the vehicle 200 shown in FIG. 2 has a rear seat occupant sensor 118 for each seating position. The occupant sensors 118 are coupled to the processor 114 through wires 119.

Each occupant sensor 118 provides a first electrically-measurable signal to the processor 114, e.g., a positive voltage or ground, when a person or object is placed on the seat cushion portion 212 of a rear seat 214. Each occupant sensor 118 provides a second and different signal to the processor (ground or a positive voltage) when the seat cushion 212 is not occupied.

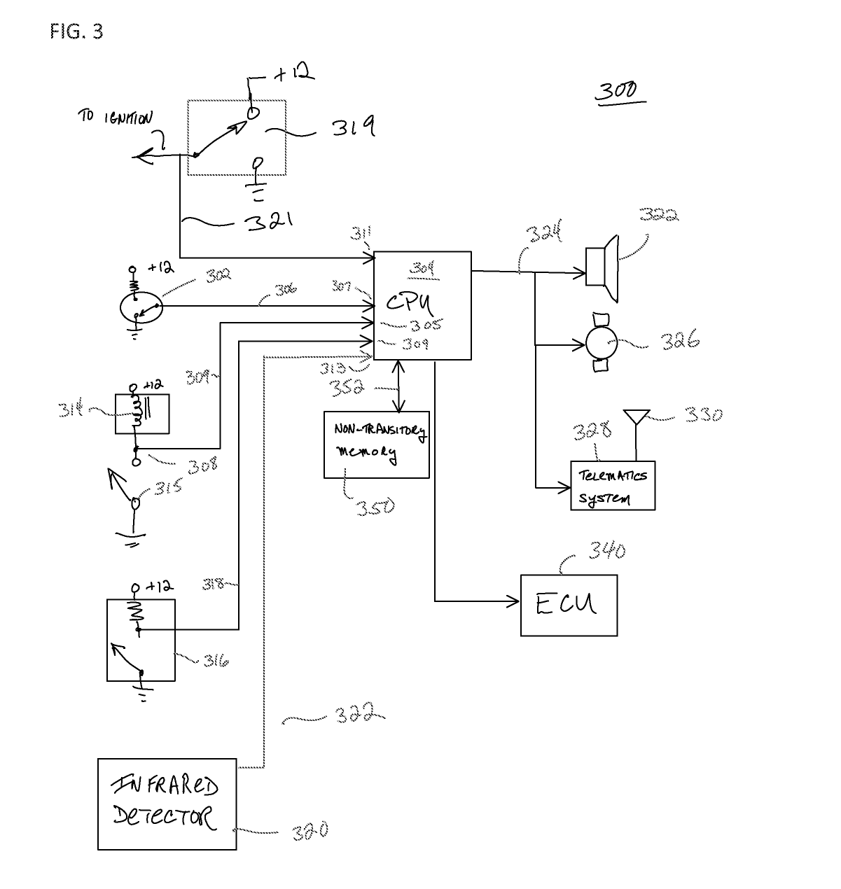

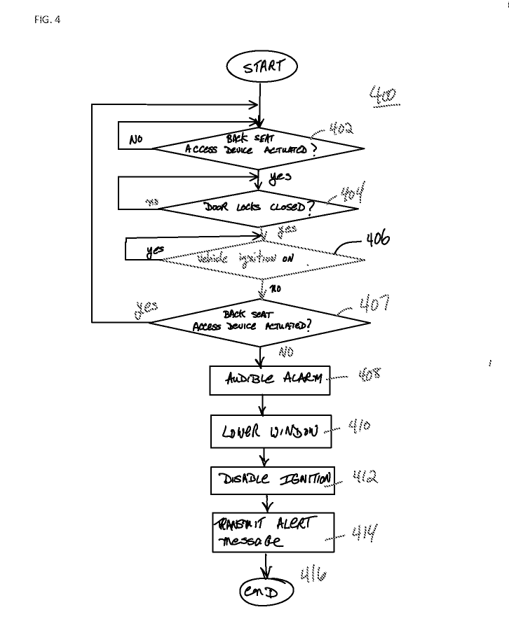

FIG. 3 is an electrical schematic diagram of an apparatus 300 for detecting an occupant in the rear seat of a motor vehicle. The apparatus 300 comprises a first sensor 302 coupled to a processor 304 via a wire 306. The first sensor 302, which in one embodiment is a common, single-pole, double-throw switch connected by a wire 306 to an input port 307 of a processor or CPU 304, provides an electrically measurable signal, i.e., a battery voltage or ground or vice-versa, when the sensor 302 transitions between open and closed positions responsive to movement of the seatback of the front seat of a two-door vehicle, not shown in FIG. 3. The sensor 302 can also be embodied as an inclinometer, well known to those of ordinary skill in the electronics art, which provides an output voltage, the magnitude of which indicates or corresponds to an angle of a seat back to which the inclinometer is attached. In either embodiment, the sensor 302 provides an electrically measurable signal to the processor 304 when the seatback of a front seat of a two-door vehicle is actuated, i.e., tilted forward enough to allow entry into the rear seat of the two-door vehicle. The seatback in a two-door vehicle is thus considered herein to be a rear seat access device, the actuation of which is detected or determined by the first sensor 302.

The apparatus 300 depicted in FIG. 3 includes a door lock position sensor 308, depicted conceptually as a wire that couples an input port 305 of the processor 304 to the ground side of a solenoid 314 that “drives” or operates a mechanical vehicle door lock, not shown in FIG. 3. The solenoid 314 as shown in FIG. 3 is actuated by operating a conventional momentary switch 315. When the switch 315 is actuated, the voltage on the wire drops to zero volts. Computer program instructions executed by the processor 304 detect the low voltage on the input port 305 and record the door locks as being actuated. The door lock position sensor thus provides a voltage to the processor that is either twelve volts or zero volts, indicating when the door locks are opened and closed. The solenoid 314, which is a prior art device, causes the electrically operated door locks of a vehicle to open and close.

FIG. 3 depicts a rear-seat occupant sensor 316 coupled to a port 309 of the processor 304 through a corresponding wire 318. As described above, the rear-seat occupant sensor 316 is actuated by a predetermined amount of weight on the seat cushion portion of the rear seat of a motor vehicle. The occupant sensor 316 thus provides an electrically measurable signal, i.e. a positive voltage or ground, indicative of whether the rear seat has a person or object placed thereon.

FIG. 3 depicts an ignition switch 319 and an ignition switch sensor 321. The ignition switch sensor is also a wire coupled to an input port 311 of the processor 304, through which the processor 304 is able to determine whether the ignition switch 319 is “on” or “off,” indicating whether the vehicle is being driven or about to be driven.

In a preferred embodiment, the apparatus 300 depicted in FIG. 3 includes an infrared detector 320 also coupled to a port 313 of the processor 304 through a wire 322. The infrared detector 320 provides a positive voltage to the processor 304 when the infrared detector “sees” an object in the rear seat 106 or 212 of a motor vehicle having a surface temperature of about ninety-eight degrees, regardless of the ambient temperature.

The processor 304 is coupled to an alarm device 322, preferably through a controller area network (CAN) bus 324, which is an automotive bus well known in the automotive art. The CAN bus 324 enables the processor 304 to operate the vehicle horn 322 responsive to signals that are sent to the horn 322 via the bus 324.

The processor 304 is coupled to one or more electrically-operated window control motors 326 through the CAN bus 324. The motors 326 raise and lower electrically-operated windows in a vehicle. The CPU 304 is thus able to raise and lower a window in the vehicle responsive to electrical signals that are sent to the motor 326 via the bus 324.

A conventional telematics system 328 is also coupled to the CPU or processor 304 via the same CAN bus 324. The telematics system 328 is a prior art device, well known to be able to send and receive messages wirelessly via a conventional antenna 330.

The processor 304 is coupled to an engine control unit or ECU 340 via the CAN bus 324. The processor 304 is thus able to control the engine's control unit 340 including disabling the ignition system for the vehicle.

Finally, the processor 304 is coupled to one or more non-transitory memory devices 350 through a conventional address/data/control bus 352. The non-transitory memory devices 350, which are collectively referred to hereinafter as a single device 350, store program instructions which when executed by the processor 304 cause the processor to read signals provided by the sensors and transmit signals to one or more of the alarm or horn 322, motors 326, telematics system 328 or ECU 340. Signals sent to the processor 304 and received from the processor 304 by peripheral devices cause those devices to perform steps of a method of detecting a back seat occupant, which method is described hereinafter and depicted in FIG. 4. Put simply, the executable instructions cause the processor 304 to monitor various sensors, determine a likelihood of whether a person or animal might be locked or confined in the rear seat of an automobile inadvertently and activate one or more alarm devices and/or cause a telematics device to transmit an emergency alert message to a telematics service provider.

FIG. 4 depicts steps of a method 400 of detecting an occupant in the rear seat of a motor vehicle. At step 402, sensors are monitored by a processor to determine whether an access device for a rear seat of the vehicle has been actuated. The actuation of a rear seat access device is thus presumed to indicate that someone or something has been placed into the rear seating area of the vehicle.

A sensor for a rear seat access device includes any device that is able to detect whether the rear seat of an automobile has been accessed. As described above, the rear seat of a two-door vehicle having front and rear seats is normally accessed by moving the seatback of at least one of the front seats forward. The seat back of front seat is thus considered to be a rear-seat access device. A sensor for such a seat back can thus include a switch as well as an inclinometer.

The rear seat of a four-door vehicle is typically accessed directly through one of the vehicle's rear doors. A rear seat access device for a vehicle having four or more doors is thus considered to be one or both rear doors or a hatch. A sensor for such a door or hatch is preferably embodied as a switch, commonly installed in vehicles to operate one or more interior lights.

In the method shown in FIG. 4, when a rear seat access device has been actuated at step 402, as indicated by a signal from an access device sensor, at step 404 a test is made whether the door locks of the vehicle have been closed. Detecting the closure of a door lock can be accomplished using a method and apparatus described above, including the use of a voltage applied to a door lock solenoid or measuring a current passing through a solenoid responsive to actuation of a door lock switch.

In vehicles that are not provided with electrically operated door locks, the door lock closure detection is provided by a simple mechanical switch, similar to the door closure switches used on vehicles. Such a switch is mechanically coupled to the lock button that projects upwardly from the top of a door panel.

When a person or object is placed into the rear seat of a motor vehicle, that placement requires the use or actuation of an access device. Removing the person or object usually requires the same access device be actuated again. For purposes of the method shown in FIG. 4, it is assumed that if a back seat door is opened once, or a seat back of a front seat is moved forward once, the actuation of such a device was to place a person or object into the rear seat. For purposes of the method, it is assumed that if the door locks are closed after the rear seat access device is actuated, it can be inferred that a person or object is in the vehicle until the rear seat access device is used a second time.

After determining whether the locks are closed at step 404, at step 406 the method 400 determines whether the vehicle ignition is “on” or “off.” If the ignition switch is on, the method assumes that the vehicle is either being driven or will be driven soon. A person or object placed into the back seat is considered to be properly secured therein if the door locks have been closed. Step 406 thus continues to check the status of the ignition key in a loop. If on the other hand the door locks are closed and the ignition is off, the method 400 assumes that the person or object placed into the back seat at step 402 is still in the vehicle and since the ignition is off, the vehicle is about to be left unattended by the driver or other person operating the access device and door locks.

After determining the ignition to be off at step 406, at step 407, the back seat access device is monitored to determine whether it is re-actuated, indicating that the person or object placed into the back seat has been removed. If at step 407 the rear seat access device is determined to have been actuated a second time, the method 400 assumes that, since the ignition is off, the second actuation of the back seat access device was made in order to remove the person or object, previously assumed to have been placed into the rear seat. The method thus returns to step 402 where the method is re-started. If on the other hand the rear seat access device is not re-activated after the door locks are closed and the ignition is off, it can be fairly assumed that the object or person placed in the rear seat is still in the rear seat. The subsequent steps, 408, 410, 412, and 414 respectively provide an audible alarm, typically the vehicle horn, partially or completely lowering at least one vehicle window, disabling the vehicle's ignition, and transmitting an alert message via the telematics system described above. If on the other hand the rear seat has been accessed again, the method skips the alarm steps and assumes that the person or object placed into the rear seat has been removed.

In a preferred embodiment, step 407 includes a time period during which the back seat access device is monitored for actuation. The time period to wait for actuation of the back seat access device before initiation alarms is typically less than about thirty (30) seconds.

In at least one alternate embodiment, a step between 406 and 408 provides for the disablement of the method 400 and avoids having the alarms 408, 410, 412, and 414 not generated. Stopping or disabling the alarms can be made by way of a unlock button on a key fob or a soft key on a display screen of the vehicle.

The foregoing description is for purposes of illustration only. The true scope of the invention is set forth in following claims.

1. A method of detecting an occupant in a back seat of a motor vehicle having front and back seats, the motor vehicle also having a telematics system and having at least front doors that provide access to at least the front seat, said doors having door locks, the method comprising:
detecting a first actuation of a back seat access device;
detecting activation of a rear seat occupant sensor, after detecting the first actuation of the back seat access device; the rear seat occupant sensor being, configured to detect objects in the back seat;
monitoring the door locks after detecting the first actuation of the back seat access device;
detecting closure of the door locks after detecting the first actuation of the back seat access device;
after detecting closure of the door locks after the first actuation of the back seat access device, monitoring an ignition switch of the vehicle to determine when the ignition switch is turned on;
activating an audible alarm when the ignition switch is turned off, if the motor vehicle's door locks were closed after the first actuation of the back seat access device and if the rear seat occupant sensor indicates the presence of an object in the back seat after the first actuation of the back seat access device if there is no second actuation of the back seat access device; and
transmitting an alert message from the motor vehicle's telematics system.

2. The method of claim 1, wherein the rear seat occupant sensor comprises an infrared detector configured to detect objects having a surface temperature substantially equal to ninety-eight degrees, the method of claim 1 further comprising:
detecting a surface temperature of an object in the back seat.

3. The method of claim 1, wherein the motor vehicle has front doors and no rear doors, wherein the back seat access device comprises:
a front seat back, which is coupled to an inclinometer, the inclinometer indicating an inclination angle of the front seat back.

4. The method of claim 2, further comprising: deactivating the audible alarm by opening the motor vehicle's door locks and actuating the back seat access device a second time.

5. The method of claim 2, further comprising: deactivating the audible alarm by operating a switch in the motor vehicle.

6. (canceled)

7. The method of claim 4, wherein the motor vehicle comprises electrically operated windows, the method further comprising:
lowering at least one electrically operated window, after the audible alarm is activated.

8. The method of claim 4, wherein the motor vehicle comprises an ignition system, the method further comprising: disabling the ignition system after the audible alarm is activated.

9. (canceled)

10. An apparatus for detecting an occupant in a back seat of a motor vehicle having an ignition switch, front and back seats, a telematics system and having doors through which the front and back seats can be accessed, the motor vehicle having a back seat access device, which provides access to the back seat, the apparatus comprising:
a first sensor coupled to the back seat access device, the first sensor being configured to provide an electrically measurable signal when the back seat access device is operated in order to access the back seat;
a back seat occupant detector configured to provide a signal indicating the presence in the back seat of an object in the back seat of the motor vehicle;
a motor vehicle door lock position sensor, configured to detect whether a motor vehicle door lock is open or closed;
an audible alarm device, configured to generate an audible alarm responsive to receipt of an alarm signal;
a processor coupled to the first sensor, motor vehicle door lock position sensor, back seat occupant detector, ignition switch, the telematics system and the audible alarm device; and
a non-transitory memory device (memory device) coupled to the processor, the memory device storing program instructions, which when executed cause the processor to:
evaluate the electrically measurable signal from the first sensor and determine if the first sensor's electrically measurable signal indicates that the back seat access device has been operated to access the back seat;
evaluate the signal from the back seat occupant detector;
detect closure of the motor vehicle's door locks after the first actuation of the back seat access device; and
generate and send the alarm signal to the audible alarm device responsive to a determination by the processor that the back seat access device was operated only once prior to closing the motor vehicle door locks, when the signal from the back seat occupant detector indicates that there, an object in the back seat and after the ignition switch is turned off after being on, the program instructions additionally causing the telematics system to transmit an alert message from the motor vehicle's telematics system.

11. The apparatus of claim 10, wherein the motor vehicle has only two doors, which are configured to provide access to both the front and back seats, wherein the front seats have seat backs which provide access to the back seat, the seat backs of the front seats comprising back seat access devices, the first sensor comprising:
an inclinometer coupled to at least one of the front seat backs.

12. The apparatus of claim 10, wherein the memory device includes instructions, which when executed, cause the processor to activate the audible alarm device when the motor vehicle's door locks are closed and the first sensor indicates that, prior to the door lock's closure, the back seat was accessed only once.

13. The apparatus of claim 10, wherein the memory device stores program instructions, which when executed cause the processor to:
activate the audible alarm device, if the motor vehicle's door locks are closed after the first actuation of the back seat access device, and if the back seat occupant detector provides said signal indicating presence of an object in the back seat after the first actuation of the back seat access device.

14. The apparatus of claim 10, further comprising:
electrically operated motor vehicle windows, operatively coupled to the processor; and
wherein the memory device stores program instructions, which when executed cause the processor to lower at least one electrically operated window, after the alarm signal is generated.

15. The apparatus of claim 10, further comprising an ignition system coupled to the processor, and wherein the memory device stores program instructions, which when executed cause the processor to disable the ignition system after the alarm signal is generated.

16. The apparatus of claim 10, further comprising an infrared detector configured to detect objects in the back seat having a surface temperature substantially equal to ninety-eight degrees, the infrared detector being operatively coupled to the processor.
